(19) United States
(12) Patent Application Publication
(10) Pub. No.: US 2018/0364497 A1
(43) Pub. Date: Dec. 20, 2018

(54) MODULAR EYEWEAR SYSTEM

(71) Applicants: Guliana PARIS, Natanya (IL); Ofir Yosef PARIS, Milan (IT)

(72) Inventor: Ofir Yosef PARIS, MILAN (IT)

(21) Appl. No.: 15/780,507

(22) PCT Filed: Dec. 2, 2016
(86) PCT No.: PCT/IB2016/057294

§ 371 Date: May 31, 2018

Related U.S. Application Data
(60) Provisional application No. 62/262,399, filed on Dec. 3, 2015.

(51) Int. Cl. G02C 5/02

(52) U.S. Cl. CPC G02C 5/02; G02C 2200/08

(57) ABSTRACT

A modular eyewear system is disclosed that comprises a plurality of bridges and at least one of a plurality of left lens holders and a plurality of right lens holders. Any one of the bridges can be assembled with any one of the left lens holders and/or the right lens holders. Further embodiments of the modular eyewear system, methods of assembly, and uses thereof are disclosed herein.

### CROSS-REFERENCE TO RELATED APPLICATIONS

The present application claims priority to United States provisional patent application No. 62/262,399, filed 3 Dec. 2015.

### FIELD

The present subject matter relates to eyewears. More particularly, the present subject matter relates to modular eyewears.

### BACKGROUND

Eyewears, also known as glasses, eyeglasses, spectacles or goggles, are frames bearing lenses worn in front of the eyes, used for vision correction or protection of the eyes against light or radiation or to prevent the impact of flying objects with the eyes. Eyewear frames generally include two lens holders, also known as rims or eyewires, which hold the lenses in place, and a bridge, which connects the two lens holders. Additionally, eyewear frames may include at least one earpiece, also known as temple, which is connected to a lens holder and placed against a side of the skull up to the ear.

In addition to their use for vision correction and eye protection, eyewears are also worn for aesthetic and fashion purposes, or as style accessories. Thus, choosing an eyewear frame that suits the customer's aesthetic and fashion desires is often a challenging task when an eyewear is purchased. Another challenge raised during the choosing of an eyewear frame is the selection of an eyewear frame that fits the size and shape of the customer's face.

It is therefore an object of the present subject matter to provide a system that will enable an easy combination of parts of an eyewear frame according to the customer's desire when an eyewear is purchased. Further objects and advantages of this subject matter will appear as the description proceeds.

### SUMMARY

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

According to one aspect of the present subject matter, there is provided a modular eyewear system, comprising: a plurality of bridges; and at least one of: a plurality of left lens holders; and a plurality of right lens holders, wherein any one of the bridges can be assembled with any one of the left lens holders and/or the right lens holders.

According to one embodiment, each left lens holder comprises a left lens holder body and a bridge connector; each right lens holder comprises a right lens holder body and a bridge connector; and each bridge comprises: a bridge body, and at least one of: a left lens holder connector, adapted to connect to the bridge connector of the left lens holder; and a right lens holder connector, adapted to connect to the bridge connector of the right lens holder.

According to another embodiment, the size and shape of the left lens holder connector of a bridge corresponds to the size and shape of a bridge connector of a left lens holder, in a manner that the left lens holder connector overlaps with the bridge connector, and the size and shape of the right lens holder connector of a bridge corresponds to the size and shape of a bridge connector of a right lens holder, in a manner that the right lens holder connector overlaps with the bridge connector.

According to yet another embodiment, the size and shape of the left lens holder connectors in a plurality of bridges and the size and shape of the bridge connectors in a plurality of left lens holders is uniform, thus allowing the connection of any bridge with any left lens holder, and wherein the size and shape of the right lens holder connectors in a plurality of bridges and the size and shape of the bridge connectors in a plurality of right lens holders is uniform, thus allowing the connection of any bridge with any right lens holder.

According to a further embodiment, a bridge connector is a female connector having a cavity, and the corresponding left lens holder connector or the corresponding right lens holder connector is a male connector, adapted to fit into the corresponding cavity.

According to yet a further embodiment, a bridge connector is a male connector, and the corresponding left lens holder connector or the corresponding right lens holder connector is a female connector having a cavity, wherein the bridge connector is adapted to fit into the corresponding cavity.

According to yet a further embodiment, the system further comprising a plurality of earpieces capable of being further assembled to a corresponding lens holder so as to complete the eyewear system.

According to another aspect of the present subject matter, there is provided a modular eyewear comprising: a bridge selected from a plurality of bridges of a modular eyewear system as previously described, and at least one of: a left lens holder selected from a plurality of left lens holders of a modular eyewear system as previously described; and a right lens holder selected from a plurality of right lens holders of a modular eyewear system as previously described.

According to another aspect of the present subject matter, the modular eyewear further comprising a left earpiece selected from a plurality of left earpieces and a right earpiece selected from a plurality of right earpieces, wherein the left earpiece is connected to the left lens holder and the right earpiece is connected to the right lens holder.

According to yet another aspect of the present subject matter, there is provided a method for assembling an eyewear comprising: selecting a bridge from a plurality of bridges, and connecting at least one lens holder selected from a plurality of lens holders to the bridge.

According to yet a further embodiment, the plurality of lens holders comprises a plurality of left lens holders and a plurality of right lens holders.

According to yet a further embodiment, the method further comprising connecting at least one earpiece selected from a plurality of earpieces.

According to yet a further embodiment, the plurality of earpieces comprises a plurality of right earpiece and a plurality of left earpiece.

According to yet a further embodiment, the connecting at least one earpiece selected from a plurality of earpieces comprising connecting the left earpiece to the left lens holder and connecting the right earpiece to the right lens holder.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

In the drawings:

FIG. 1 schematically illustrates, according to an exemplary embodiment, a front view of a modular eyewear system comprising a set of bridges, a set of left lens holders and a set of right lens holders.

FIG. 2 schematically illustrates, according to an exemplary embodiment, a perspective view of a bridge connector of a right lens holder.

FIG. 3 schematically illustrates, according to an exemplary embodiment, (A) not-assembled, (B) partially assembled and (C) fully-assembled bridge and a bridge connector of a right lens holder, in front and perspective views.

FIG. 4 schematically illustrates, according to an exemplary embodiment, a perspective view of a right lens holder and a right earpiece.

FIG. 5 schematically illustrates, according to an exemplary embodiment, a perspective view of a right earpiece connector of a right lens holder.

FIG. 6 schematically illustrates, according to an exemplary embodiment, a perspective view of a right lens holder attaching element of a right earpiece.

FIGS. 7A-F schematically illustrate, according to an exemplary embodiment, a perspective side view (FIGS. 7A,C,E) and an upper view (FIGS. 7B,D,F) of three stages of an assembly process of a right earpiece connector with a right lens holder attaching element, having the preferred structural feature disclosed in FIGS. 5 and 6, respectively.

FIG. 8 schematically illustrates, according to an exemplary embodiment, a side perspective view of a left earpiece connector configured to the welded to a left lens holder body.

FIGS. 9A-B schematically illustrate, according to an exemplary embodiment, a top view and a side perspective view, respectively, of an assembled eyewear comprising a right lens holder and a left lens holder attached to a bridge, as well as a right earpiece connector and a left earpiece connector that are to be welded to the right lens holder body and the left lens holder body, respectively.

FIG. 10 schematically illustrates, according to an exemplary embodiment, a side perspective view of a left earpiece connector configured to the attached by heating to a left lens holder body.

FIGS. 11A-B schematically illustrate, according to an exemplary embodiment, a top view and a side perspective view, respectively, of an assembled eyewear comprising a right lens holder and a left lens holder attached to a bridge, as well as a right earpiece connector and a left earpiece connector hat are to be attached by heating, through their respective pins and to the right lens holder body and the left lens holder body, respectively.

FIGS. 12A-D schematically illustrate, according to an exemplary embodiment, a perspective side view (FIGS. 1A,C) and an upper view (FIGS. 12B,D) of two stages of an assembly process of a left earpiece connector with a left lens holder attaching element, when the left lens holder attaching element body is bent.

FIGS. 13A-D schematically illustrates, according to an exemplary embodiment, stages of a method for assembling a left earpiece with a left lens holder attaching element comprising a bent left lens holder attaching element body.

FIGS. 14A-D schematically illustrate, according to an exemplary embodiment, a perspective side view (FIGS. 14A,C) and an upper view (FIGS. 14B,D) of two stages of an assembly process of a left earpiece connector with a left lens holder attaching element, when the left lens holder attaching element body serves as a female connector.

FIGS. 15A-D schematically illustrate, according to an exemplary embodiment, stages of a method for assembling a left earpiece with a left lens holder attaching element comprising a left lens holder attaching element body serving as a female connector.

FIGS. 16A-C schematically illustrate, according to an exemplary embodiment, a side perspective view of stages of a method for assembling a left earpiece with a left lens holder.

### DESCRIPTION OF THE PREFERRED EMBODIMENTS

Before explaining at least one embodiment in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

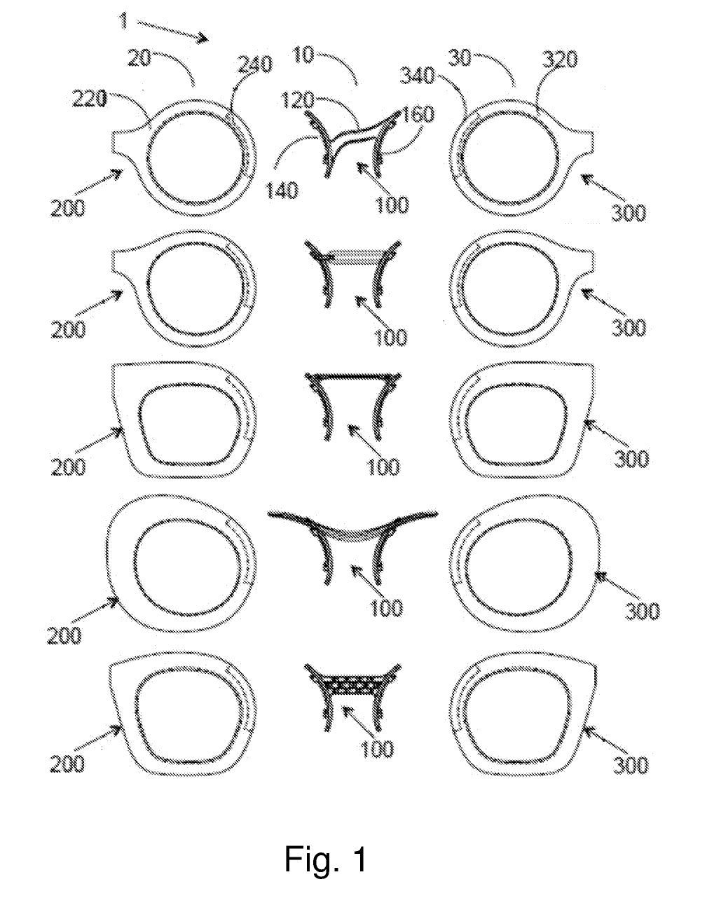

FIG. 1 schematically illustrates, according to a preferable exemplary embodiment, a front view of a modular eyewear system 1 comprising a set of bridges 10 further comprising a plurality of bridges 100, a set of left lens holders 20 further comprising a plurality of left lens holders 200, and a set of right lens holders 30 further comprising a plurality of right lens holders 300.

According to another embodiment, the modular eyewear system 1 comprises a set of bridges 10 further comprising a plurality of bridges 100, and either a set of left lens holders 20 further comprising a plurality of left lens holders 200, or a set of right lens holders 30 further comprising a plurality of right lens holders 300.

In a preferred embodiment, each bridge 100 comprises a bridge body 120, a left lens holder connector 140 and a right lens holder connector 160. In another embodiment, each bridge 100 comprises a bridge body 120, and either a left lens holder connector 140 or a right lens holder connector 160. The bridge body 120 may be made of any material known in the art and be in any size, shape, color and decoration style. Thus, the set of bridges 10 comprises a variety of bridges 100 having bridge bodies 120 in different shapes, sizes, colors and decoration styles. The left lens holder connector 140 is adapted to connect to a bridge connector 240 of a left lens holder 200, whereas the right lens holder connector 160 is adapted to connect to a bridge connector 340 of a right lens holder 300.

Each left lens holder 200 comprises a left lens holder body 220 and a bridge connector 240. The left lens holder body 220 may be made of any material known in the art and be in any size, shape, color and decoration style. Thus, the set of left lens holders 20 comprises a variety of left lens holders 200 having left lens holder bodies 220 in different shapes, sizes, colors and decoration styles. The bridge connector 240 is adapted to connect to the left lens holder connector 140 of a bridge 100.

Each right lens holder 300 comprises a right lens holder body 320 and a bridge connector 340. The right lens holder body 320 may be made of any material known in the art and be in any size, shape, color and decoration style. Thus, the set of right lens holders 30 comprises a variety of right lens holders 300 having right lens holder bodies 320 in different shapes, sizes, colors and decoration styles. The bridge connector 340 is adapted to connect to the right lens holder connector 160 of a bridge 100.

Thus, the variety of bridge holders 100, left lens holders 200 and right lens holders 300, having different sizes, shapes, colors and decoration styles and made of various materials enables the customer to assemble a combination of a bridge holder 100, a left lens holder 200 and a right lens holder 300 that fits his aesthetic and fashion desires in one hand, and his facial size and shape on the other hand.

The size and shape of the left lens holder connector 140 of a bridge 100 corresponds to the size and shape of the bridge connector 240 of a left lens holder 200, in a manner that the left lens holder connector 140 overlaps with the bridge connector 240. In addition, the size and shape of the left lens holder connectors 140 in a set of bridges 100 and the size and shape of the bridge connectors 240 in a set of left lens holders 20 is uniform, thus allowing the connection of any bridge 100 with any left lens holder 200.

Similarly, the size and shape of the right lens holder connector 160 of a bridge 100 corresponds to the size and shape of a bridge connector 340 of a right lens holder 300, in a manner that the right lens holder connector 160 overlaps with the bridge connector 340. In addition, the size and shape of the right lens holder connectors 140 in a set of bridges 100 and the size and shape of the bridge connectors 340 in a set of right lens holders 30 is uniform, thus allowing the connection of any bridge 100 with any right lens holder 300.

In one embodiment, the size and shape of the left lens holder connector 140 and the corresponding bridge connector 240 is similar to the size and shape of the right lens holder connector 160 and the corresponding bridge connector 340, as shown in FIG. 1. In another embodiment, the size and shape of the left lens holder connector 140 and the corresponding bridge connector 240 is different from the size and shape of the right lens holder connector 160 and the corresponding bridge connector 340 of a bridge 100 (not shown).

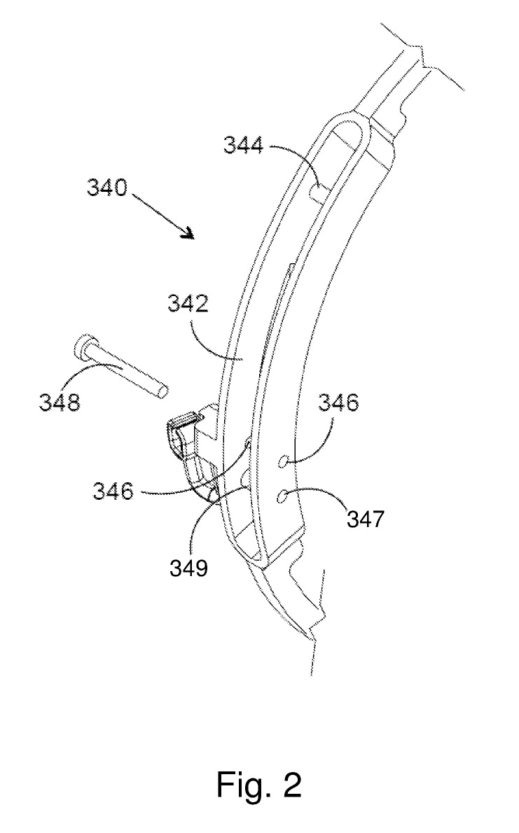

FIG. 2 schematically illustrates, according to an exemplary embodiment, a perspective view of a bridge connector 340 of a right lens holder 300. It is appreciated that the features of the bridge connector 340 of a right lens holder 300 disclosed as follows refer also to a bridge connector 240 of a left lens holder 200. According to one embodiment, the bridge connector 340 is a female connector having a cavity 342, and the corresponding right lens holder connector 160 is a male connector, adapted to fit into the corresponding cavity 342. According to yet another embodiment, the bridge connector 340 is a male connector and the corresponding right lens holder connector 160 is a female connector having a cavity (not shown).

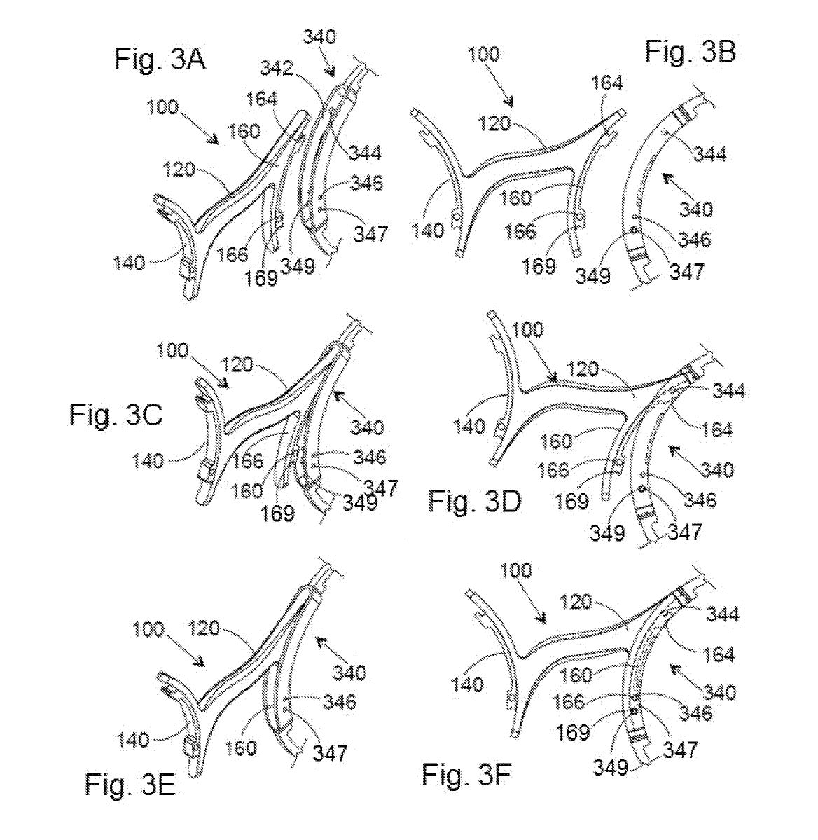

According to additional embodiments, the cavity 342 comprises additional structural features aimed at facilitating the attachment of the right bridge holder 340 to the corresponding right lens holder connector 160, given that the structure of the right lens holder connector 160 matches the additional structural features of the cavity 342. According to one embodiment, an additional structural feature in the cavity is a rod-like structure 344. Thus, the corresponding right lens holder connector 160 comprises a hook 164 adapted to engage with the rod-like structure 344, as can be seen in FIG. 3. The engagement of the hook 164 with the corresponding rod-like structure 344 allows tight attachment of the bridge 100 with the left lens holder 300, thus allowing easy evaluation of the combination of the eyewear frame components during a purchase process.

Turning now back to FIG. 2, according to another embodiment of the present invention, the cavity 342 comprises a first rod-like structure 344 and a second rod-like structure 347, whereas the corresponding right lens holder connector 160 comprises a first hook 164 adapted to engage with the first rod-like structure 344, and a second hook 169 adapted to engage with the second rod-like structure 347, as shown in FIG. 3.

According to yet another embodiment of the present invention, a pipe-like element 349 covers the second rod-like structure 347, in a manner the allows rotation of the pipe-like element 349 around the second rod-like structure 347. The addition of the pipe-like element 349 facilitates a tighter attachment with the corresponding second hook 169 of the right lens holder connector 160.

In a further embodiment, the bridge connector 340 further comprises a means for locking the bridge connector 340 with the right lens holder connector 160 once a combination of a bridge 100 and a right lens holder 300 is chosen. According to an embodiment disclosed in FIG. 2, the means for locking comprises at least one hole 346 in each wall of the cavity 342, adapted to receive a locking member 348, given that the right lens holder connector 160 has matching at least one hole, so that the locking member 348 enters through the holes 346 in the bridge connector 340 and the holes in the right lens holder connector 160. The locking member 348 may be of any kind known in the art, for example a screw.

FIGS. 3A-F schematically illustrate, according to an exemplary embodiment, a side perspective view (FIGS. 3A,C,D) and a side view (FIGS. 3B,D,F) of not-assembled (FIGS. 3A-B), partially assembled (FIGS. 3C-D) and fully-assembled (FIGS. 3E-F) bridge 100 and a bridge connector 340 of a right lens holder 300. According to this embodiment, the bridge connector 340 is a female connector having a cavity 342, and the corresponding right lens holder connector 160 is a male connector, adapted to fit into the cavity 342. In addition, the bridge connector 340 further comprises a first rod-like structure 344 and the right lens holder connector 160 further comprises a corresponding hook 164 adapted to engage with the rod-like structure 344. In addition, the bridge connector 340 further comprises a second rod-like structure 347 covered with a pipe-like structure 349, and the right lens holder connector 160 further comprises a corresponding hook 169 adapted to engage with the pipe-like element 349 which covers the second hook-like structure 347. Furthermore, the bridge connector 340 comprises a hole 346 on both walls of the cavity 342 and the right lens holder connector 160 comprises a corresponding hole 166 adapted to align with the hole 346 of the bridge connector 340, in order to enable the entrance of a locking member 348 (shown in FIG. 2) for locking the right bridge connector 340 with the right lens holder connector 160 in a full-assembly position.

According to one embodiment, as shown in FIG. 3, a method for assembling a bridge 100 with a right lens holder 300 comprises engaging the first hook 164 of the right lens holder connector 160 with the first rod-like structure 344 of the bridge connector 340, as shown in FIG. 3B, followed by fully inserting the right lens holder connector 160 into the cavity 342 of the bridge connector 340, while engaging the second hook 169 with the pipe-like element 349 which covers the second rod-like structure, as shown in FIG. 3C. It is appreciated that assembly of a bridge 100 with a left lens holder 200 is conducted similarly.

In order to disassemble the combination of the bridge 100 and the right lens holder 300, the bridge connector 340 is pulled away from the right lens holder connector 160, while separating the second hook 169 and the first hook 164 from the corresponding rod-like structures that they are engaged with. Similarly, the bridge 100 is separated from the left lens holder 200. Now another left lens holder 200 and/or right lens holder 300 may be attached to the bridge 100 as disclosed previously with regard to FIG. 3.

In another embodiment, the modular eyewear system 1 comprises a set of bridges 10 further comprising a plurality of bridges 100, a set of left lens holders 20 further comprising a plurality of left lens holders 200, and a set of right lens holders 30 further comprising a plurality of right lens holders 300, as described herein, and in addition the modular eyewear system 1 further comprises a set of left earpieces further comprising a plurality of left earpieces, and a set of right earpieces further comprising a plurality of right earpieces. The body of a left and right earpiece may be made of any material known in the art and be in any size, shape, color and decoration style. Thus, the set of left earpieces and the set of right earpieces comprise a variety of left and right earpieces, respectively, in different shapes, sizes, colors and decoration styles, which may be made of various materials.

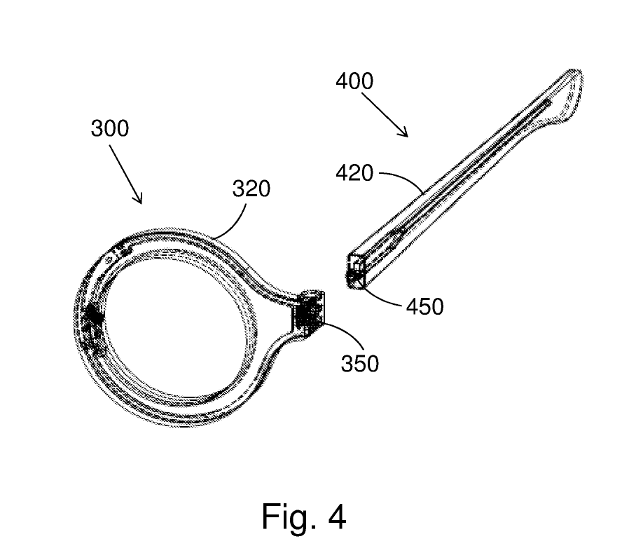

FIG. 4 schematically illustrates, according to an exemplary embodiment, a perspective view of a right lens holder 300 and a right earpiece 400. It is appreciated that the features of the right lens holder 300 and the right earpiece 400 disclosed as follows refer also to a left lens holder 200 and a left earpiece. In addition to the features described herein, the right lens holder 300 further comprises a right earpiece connector 350, located on the right lens holder body 320. In one embodiment, the right earpiece connector 350 is a female axis 350, as shown in FIG. 4. The right earpiece 400 comprises a right earpiece body 420, that may be made of any material known in the art and be in any size, shape, color and decoration style. In addition, the right earpiece 400 comprises a right lens holder attaching element 450 located in the side of the right earpiece 400 that is proximal to the right lens holder 300. In one embodiment, the right lens holder attaching element 450 is a male attaching element 450, as shown in FIG. 4. In another embodiment, the right earpiece connector 350 is a male connector and the right lens holder connector 240 is a female axis (not shown). The right lens holder attaching element 450 is adapted to connect with the right earpiece connector 350, thus attaching the right earpiece 400 to the right lens holder 300. According to the embodiment shown in FIG. 4, the male attaching element 450 of the right earpiece 400 is adapted to engage with the female axis 350 of the right lens holder 300, thus attaching the right earpiece 400 to the right lens holder 300.

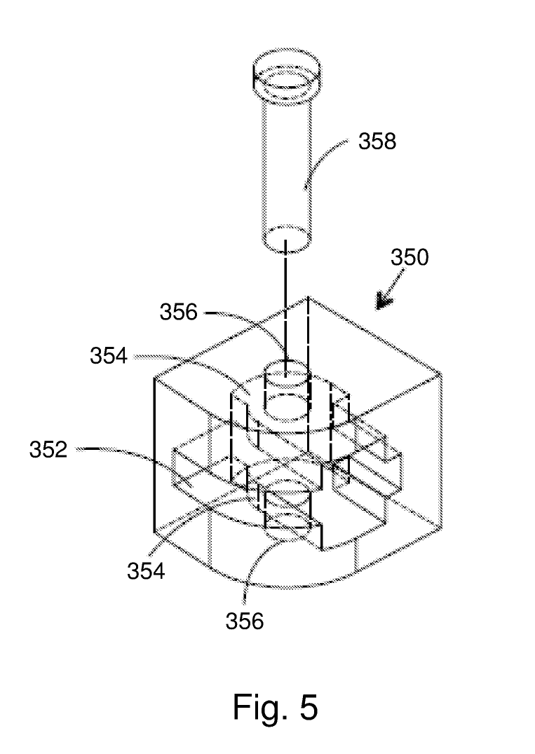

FIG. 5 schematically illustrates, according to an exemplary embodiment, a perspective view of a right earpiece connector 350 of a right lens holder 300. According to one embodiment, the right earpiece connector 350 comprises at least one crevice-like structure 354. In a preferred embodiment, the right earpiece connector 350 comprises two crevice-like structures 354 located one above the other, as shown in FIG. 5.

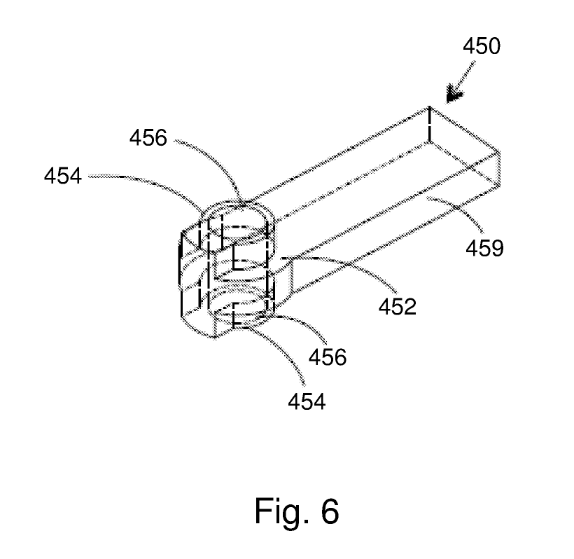

FIG. 6 schematically illustrates, according to an exemplary embodiment, a perspective view of a right lens holder attaching element 450 of a right earpiece 400. According to one embodiment, the right lens holder attaching element 450 comprises a right lens holder attaching element body 459 adapted to attach to the right earpiece body 420. The right lens holder attaching element 450 further comprises at least one protrusion-like element 454, adapted to engage with the at least crevice-like structure 354 of the right earpiece connector 350. In a preferred embodiment, the right lens holder attaching element 450 comprises two protrusion-like elements 454 located one above the other, as shown in FIG. 6.

Returning now back to FIG. 5, according to another embodiment, the right earpiece connector 350 further comprises a curved rail 352 between the two crevice-like structures 354.

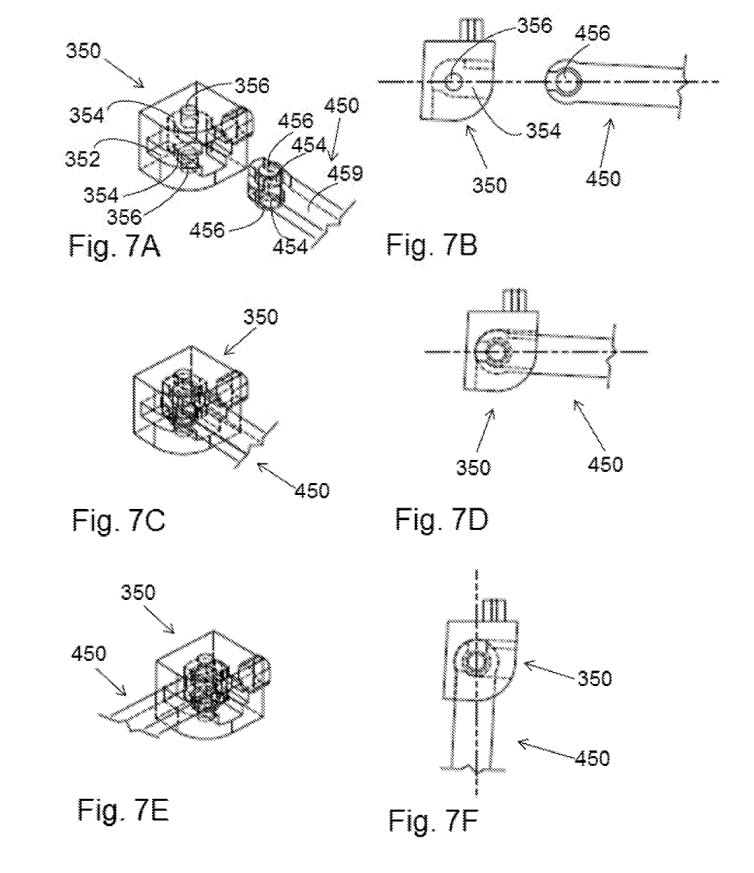

FIGS. 7A-F schematically illustrate, according to an exemplary embodiment, a perspective side view (FIGS. 7A,C,E) and an upper view (FIGS. 7B,D,F) of three stages of an assembly process of a right earpiece connector 350 with a right lens holder attaching element 450, having the preferred structural feature disclosed in FIGS. 5 and 6, respectively.

According to one embodiment, as shown in FIG. 7, a method for assembling a right lens holder 300 having a right earpiece connector 350 with a right earpiece 400 having a right lens holder attaching element 450 comprises engaging the two protrusion-like elements 454 with the corresponding two crevice-like structures 354—compare FIG. 7A with FIG. 7C, followed by turning the right earpiece 400 in a manner that turns the right lens holder attaching element 450 in the curved rail 352, as shown in FIGS. 7E-F, in order to firmly attach the right lens holder 300 with the right earpiece 400. According to one embodiment, the attachment of the right earpiece 400 with the right lens holder 300 in this manner is firm enough, and no additional locking means is necessary to firmly attach the right earpiece 400 with the right lens holder 300.

In order to disassemble the combination of the right lens holder 300 with the right earpiece 400, the right earpiece 400 is turned in a manner that turns the right lens holder attaching element 450 in the curved rail 352 back to the position shown in FIGS. 7C-D, and pulling the right earpiece 400 out in a manner that separates the right lens holder attaching element 450 from the right earpiece connector 350, as shown in FIGS. 7A-B.

Returning now back to FIGS. 5 and 6, in another embodiment, the right earpiece connector 350 further comprises a hole 356, and the right lens holder attaching element 450 further comprises a hole 456 adapted to align with the hole 356 of the right earpiece connector 350. Both holes 356 and 456 are adapted to receive a locking member 358.

According to a preferred embodiment, the locking member 358 is a screw. Turning now back to FIG. 7, when a combination of a right lens holder 300 and a right earpiece 400 is chosen by the customer, and the right lens holder attaching element 450 is firmly attached with the right earpiece connector 350, as shown in FIG. 7C, a locking member 358 is inserted into the holes 356 and 456, now aligned, in order to lock the connection between the right lens holder 300 and the right earpiece 400. It is appreciated that the assembly and locking of a left earpiece with a left lens holder 200 is conducted similarly.

According to the embodiments described herein, the modular eyewear system 1 of the present invention allows assembling of an eyewear frame while choosing the bridge, the lens holders and alternatively the earpieces from a variety of sizes, shapes, colors, decoration styles and materials. In addition, the modular eyewear system 1 of the present invention allows easy changing of any of the eyewear frame components, e.g. the bridge, the lens holders and alternatively the earpieces, during the selection process of a desired component style. According to one embodiment, when a satisfactory combination of bridge, lens holders and alternatively earpieces is chosen, their attachment to each other is firm enough, and the assembled eyewear frame can be used directly. According to another embodiment, the assembled components of the eyewear frame are locked, by using any locking means known in the art, for example but not limited to, screws and corresponding holes. A locking means is used for locking the left lens holder connector 140 of the bridge 100 with the bridge connector 240 of the left lens holder 200. Another locking means is used to lock the right lens holder connector 160 of the bridge 100 with the bridge connector 340 of the right lens holder 300. When the modular eyewear system 1 comprises a set of either right earpieces, left earpieces, or both, a locking means is used for locking the earpiece connector of the left lens holder 200 with the left lens holder of the left earpiece, and for locking the right earpiece connector 350 of the right lens holder 300 with the right earpiece attaching element 450 of the right earpiece 400.

During the manufacturing of the right lens holder 300 and the left lens holder 200 there is a need to attach a right earpiece connector 350 to a right lens holder body 320 and attach a left earpiece connector 250 to a left lens holder body 220. According to one embodiment this attachment may be by welding, for example when the right lens holder body 320 and/or the left lens holder body 220 is made of metal. According to another embodiment, this attachment may be by heating, for example when the right lens holder body 320 and/or the left lens holder body 220 is made of plastic, like acetate-based plastic.

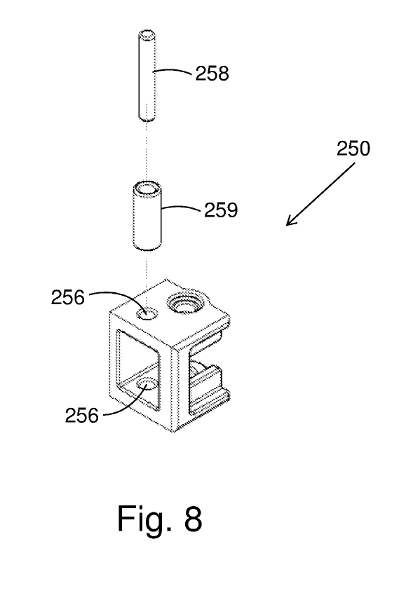

FIG. 8 schematically illustrates, according to an exemplary embodiment, a side perspective view of a left earpiece connector 250 configured to the welded to a left lens holder body 220. Embodiments of the left earpiece connector 250 illustrated in FIG. 8 are similar to the embodiments of the right earpiece connector 350 illustrated in FIG. 5, and therefore are not described again. However, in addition to the locking member 258 there is provided a cylinder 259 configured to be inserted in between the two holes 256, and accommodate the locking member 258 once inserted into the two holes 256.

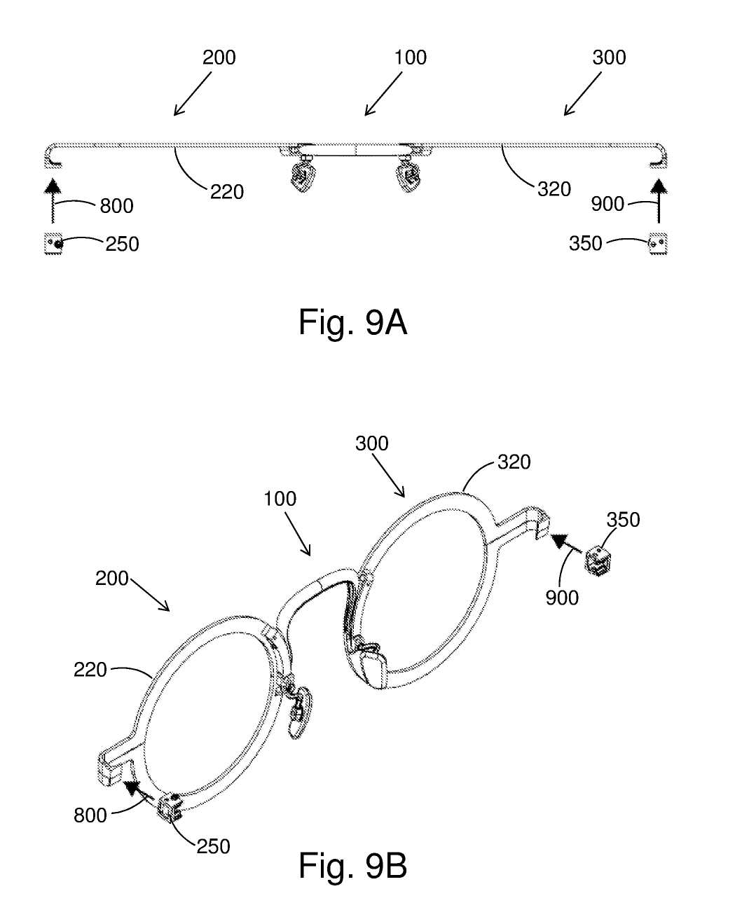

FIGS. 9A-B schematically illustrate, according to an exemplary embodiment, a top view and a side perspective view, respectively, of an assembled eyewear comprising a right lens holder 300 and a left lens holder 200 attached to a bridge 100, as well as a right earpiece connector 350 and a left earpiece connector 250 that are to be welded to the right lens holder body 320 and the left lens holder body 220, respectively. The locations of the welding are designated with arrows 800 and 900.

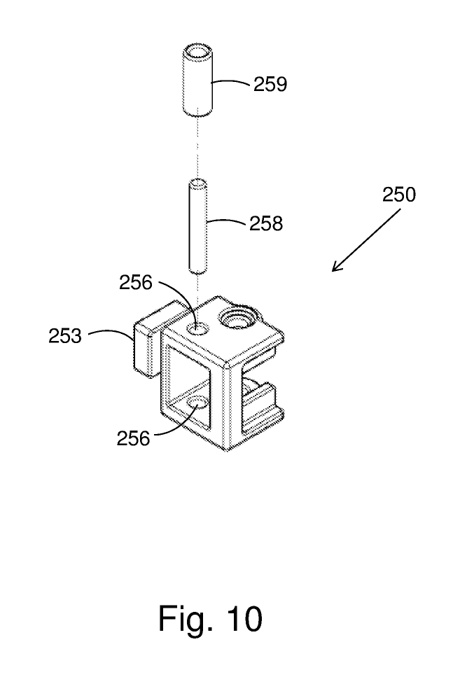

FIG. 10 schematically illustrates, according to an exemplary embodiment, a side perspective view of a left earpiece connector 250 configured to the attached by heating to a left lens holder body 220. Embodiments of the left earpiece connector 250 illustrated in FIG. 10 are similar to the embodiments of the left earpiece connector 250 illustrated in FIG. 8, and therefore are not described again. However, the left earpiece connector 250, that is configured to the attached by heating to a left lens holder body 220, further comprises a pin 253 configured to be attached to the left lens holder body 220 during heating.

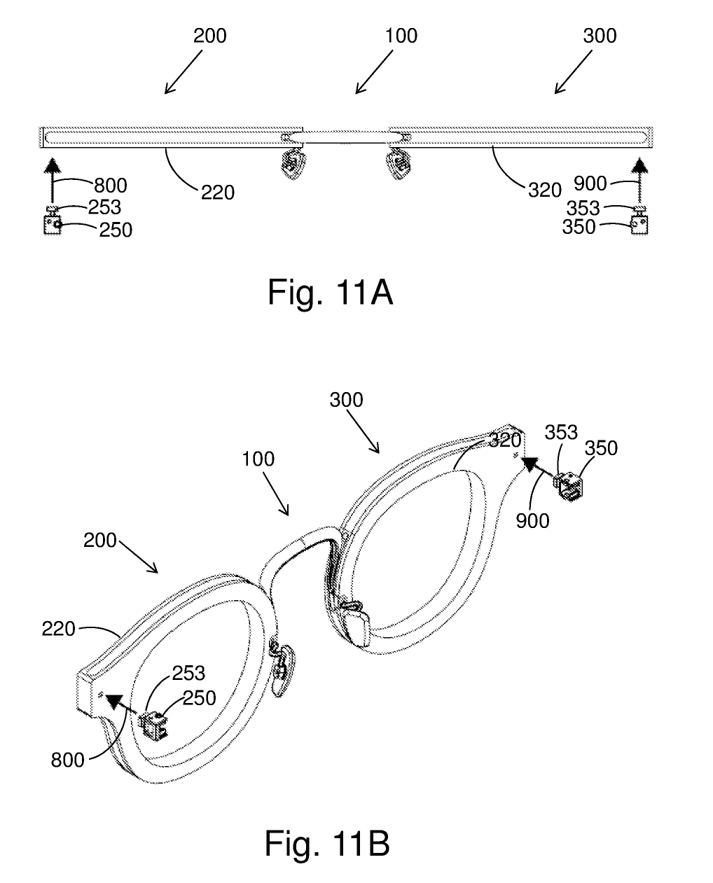

FIGS. 11A-B schematically illustrate, according to an exemplary embodiment, a top view and a side perspective view, respectively, of an assembled eyewear comprising a right lens holder 300 and a left lens holder 200 attached to a bridge 100, as well as a right earpiece connector 350 and a left earpiece connector 250 that are to be attached by heating, through their respective pins 253 and 353 to the right lens holder body 320 and the left lens holder body 220, respectively. The locations of the attachment by heating are designated with arrows 800 and 900.

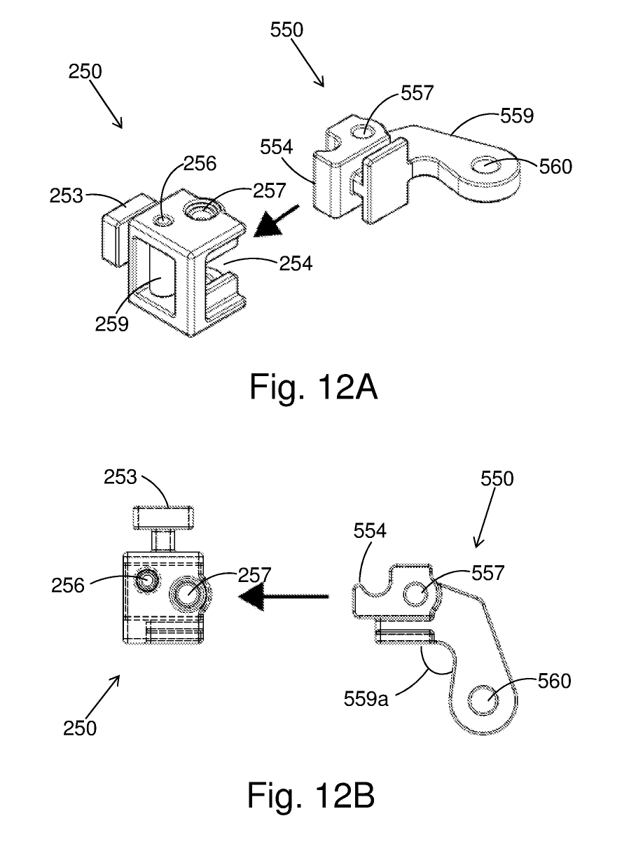

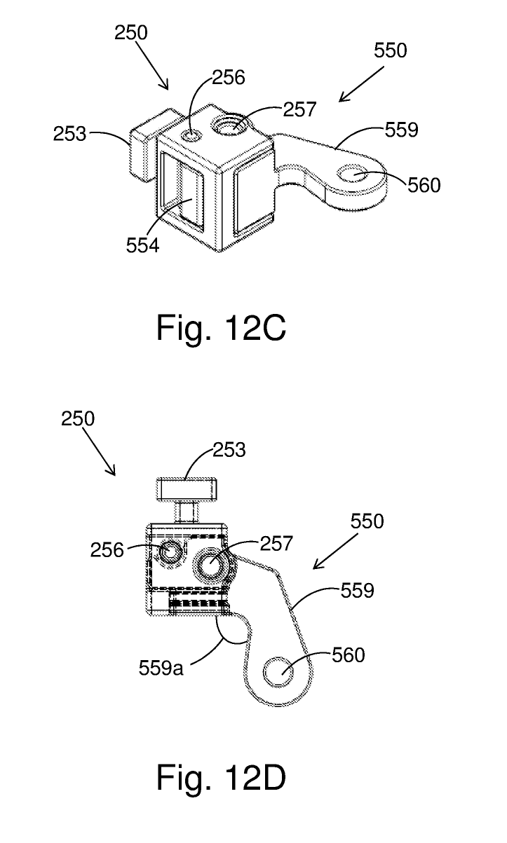

FIGS. 12A-D schematically illustrate, according to an exemplary embodiment, a perspective side view (FIGS. 12A,C) and an upper view (FIGS. 12B,D) of two stages of an assembly process of a left earpiece connector 250 with a left lens holder attaching element 550, when the left lens holder attaching element body 559 is bent and serve as a male connector.

FIG. 6 illustrates a right lens holder attaching element 450 comprising a substantially straight right lens holder attaching element body 459. Therefore, as illustrated in FIGS. 7A-F, during the assembly of the right earpiece connector 350 with the right lens holder attaching element 450, the right earpiece 400 has to be turned in a manner that turns the right lens holder attaching element 450 in the curved rail 352, as shown in FIGS. 7E-F, in order to firmly attach the right lens holder 300 with the right earpiece 400.

The present subject matter further provides additional embodiments of the modular eyewear system 1 and a method for assembling the same.

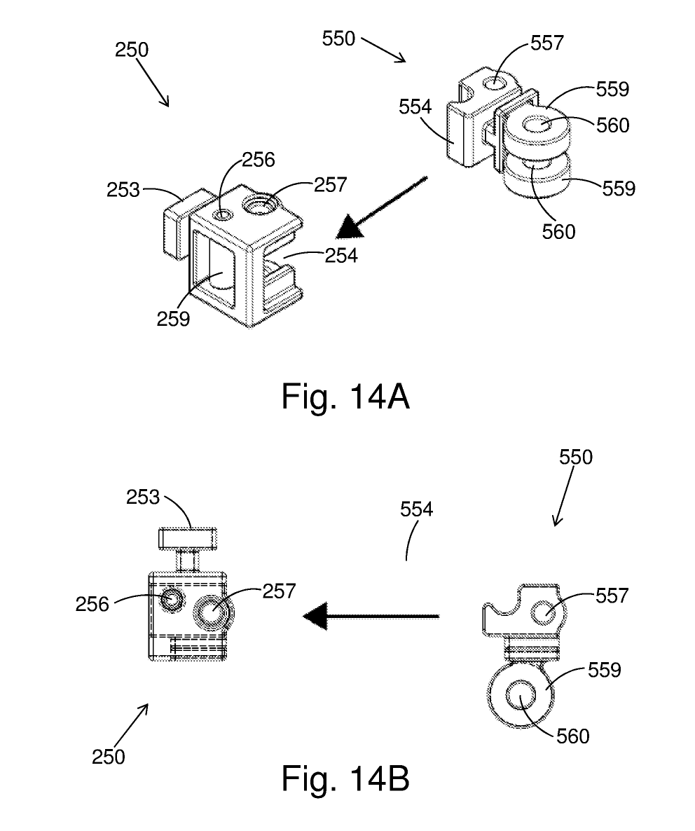

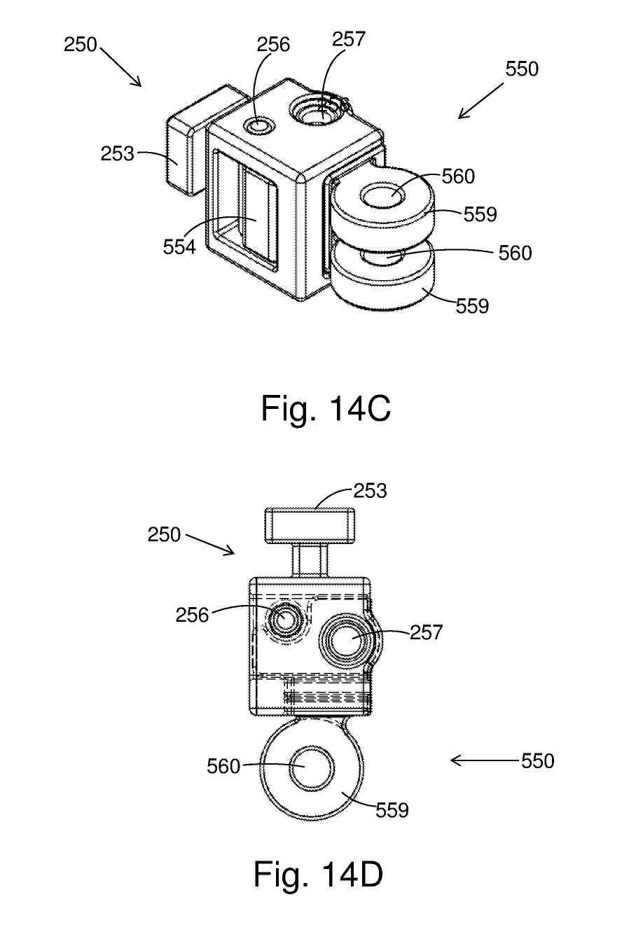

According to the embodiment illustrated in FIGS. 12A-D, the left lens holder attaching element body 559 is bent, preferably forming an angle 559a that is substantially perpendicular. The present subject matter provides a method for assembling a left lens holder 200 having a left earpiece connector 250 with a left earpiece 500 having a left lens holder attaching element 550 comprising a bent left lens holder attaching element body 559. According to one embodiment, the method comprises engaging a protrusion-like element 554 with a corresponding crevice-like structure 254—compare FIGS. 12A-B with FIGS. 12C-D. Thus, the left lens holder 200 is firmly attached with the left earpiece 500, by attaching the left lens holder attaching element 550 with the left earpiece connector 250, as described above. According to one embodiment, the attachment of the left earpiece 500 with the left lens holder 200 in this manner is firm enough, and no additional locking means is necessary to firmly attach the left earpiece 500 with the left lens holder 200. According to another embodiment, a fastening member 704, for example a screw (see FIG. 14B) may be used in order to fasten the left lens holder attaching element 550 with the a left earpiece connector 250. According to this embodiment, the left lens holder attaching element 550 further comprising a hole 557 and the left earpiece connector 250 further comprises a hole 257. When the left lens holder attaching element 550 is assembled with the left earpiece connector 250, as illustrated in FIG. 12C-D, hole 557 is aligned with hole 257, allowing a fastening member 704, for example a screw (see FIG. 14B) to be inserted or screwed into aligned holes 557 and 257, and further fasten the left lens holder attaching element 550 with the a left earpiece connector 250.

In order to disassemble the combination of the left lens holder 200 with the left earpiece 500, the left earpiece 500 is pulled out in a manner that separates the left lens holder attaching element 550 from the left earpiece connector 250—compare FIGS. 12C-D with FIGS. 12A-B. In an embodiment according to which a fastening member 704, for example a screw (not shown) is inserted or screwed into aligned holes 557 and 257, the fastening member should be disengaged in order to allow separation of the left lens holder attaching element 550 from the left earpiece connector 250.

Additional embodiment of the left earpiece connector 250 illustrated in FIGS. 12A-B, is the pin 253 that is configured to be attached to the left lens holder body 220 during heating. A described previously, the pin 253 is optional, and the left earpiece connector 250 may not comprise a pin 253, for example when the left earpiece connector 250 is configured to be welded with the left lens holder body 220.

Yet an additional embodiment of the left earpiece connector 250 illustrated in FIGS. 12A-B, is the cylinder 259 shown inserted in between the two holes 256. In this position, the cylinder is configured to accommodate a locking member 258 once inserted into the two holes 256. According to still an additional embodiment, the cylinder 259 is configured to be grasped by a protrusion-like element 554 during the assembly of a left lens holder 200 having a left earpiece connector 250 with a left earpiece 500 having a left lens holder attaching element 550, as described in FIGS. 12A-D. According to one embodiment, the grasping of the cylinder 259 by the protrusion-like element 554 is firm enough to hold the left lens holder 200 and the left earpiece 500 tightly assembled. According to another embodiment, the assembly is further tightened by using a fastening member 704, as will be described later.

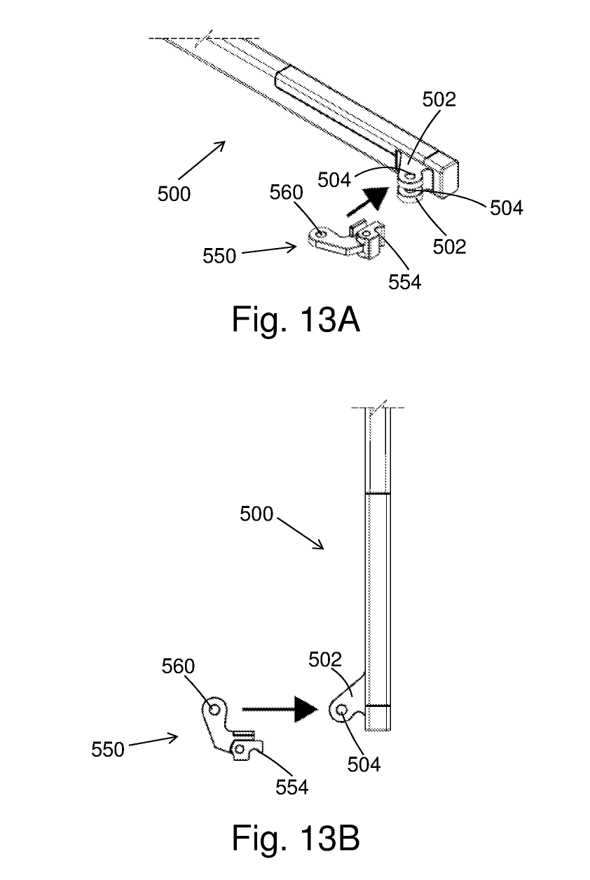

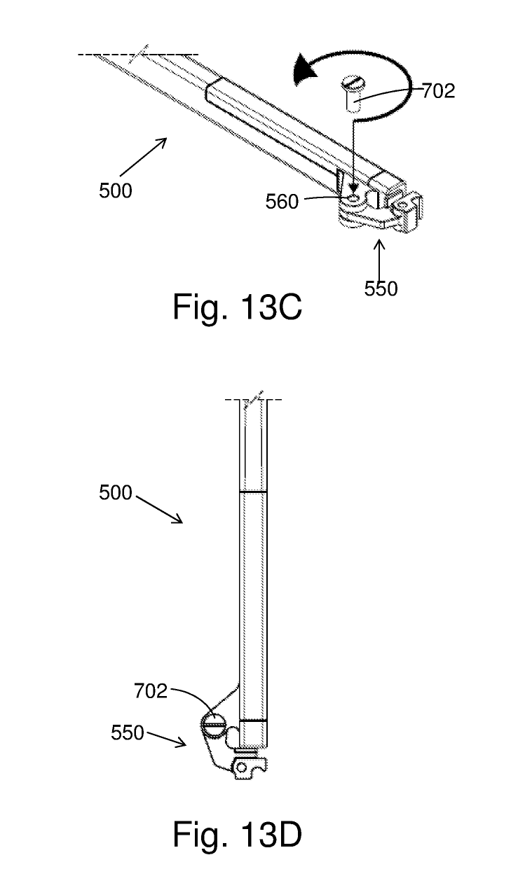

FIGS. 13A-D schematically illustrate, according to an exemplary embodiment, stages of a method for assembling a left earpiece 500 with a left lens holder attaching element 550 comprising a bent left lens holder attaching element body 559, serving as a female connector.

FIGS. 13A-B schematically illustrate, according to an exemplary embodiment, a side perspective view and a top view, respectively, of a left earpiece 500 and a left lens holder attaching element 550 separated one from the other. According to one embodiment, the left lens holder attaching element 550 is similar to the one illustrated for example in FIGS. 12A-B. The left lens holder attaching element 550 further comprises a hole 560 at a distal edge of the bent left lens holder attaching element body 559, distally to the protrusion-like element 554. Thus, the distal edge of the bent left lens holder attaching element body 559 with its hole 560 function as a male connector. An edge of the left earpiece 500 comprises a female connector configured to be engaged with the male connector of the left lens holder attaching element 550. An exemplary embodiment of the female connector of the left earpiece 500 is two earpiece protrusions 502, each comprising a hole 504. During assembly, the two earpiece protrusions 502 are configured to accommodate the distal edge of the bent left lens holder attaching element body 559 in between, in a manner that the hole 560 at the distal edge of the bent left lens holder attaching element body 559 aligns with the holes 504 of the two earpiece protrusions 502.

FIGS. 13C-D schematically illustrate, according to an exemplary embodiment, a side perspective view and a top view, respectively, of a left earpiece 500 assembled with a left lens holder attaching element 550. After the distal edge of the bent left lens holder attaching element body 559 is engaged with the two earpiece protrusions 502, and the hole 560 at the distal edge of the bent left lens holder attaching element body 559 is aligned with the holes 504 of the two earpiece protrusions 502, an axial element 702 is inserted into the three aligned holes 560 and 502. According to one embodiment, the axial element 702 is configured to hold the left earpiece 500 and a left lens holder attaching element 550 together. According to another embodiment, the axial element 702 is configured to serve as an axis for rotation of the left earpiece 500 in relation to the left lens holder attaching element 550. An exemplary axial element 702 is a screw.

FIGS. 14A-D schematically illustrate, according to an exemplary embodiment, a perspective side view (FIGS. 14A,C) and an upper view (FIGS. 14B,D) of two stages of an assembly process of a left earpiece connector 250 with a left lens holder attaching element 550, when the left lens holder attaching element body 559 serves as a female connector.

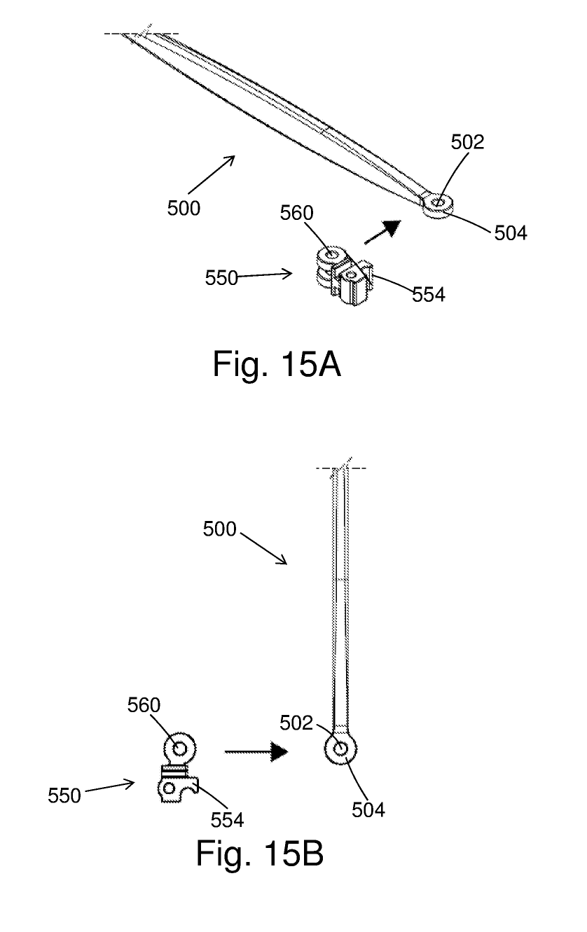

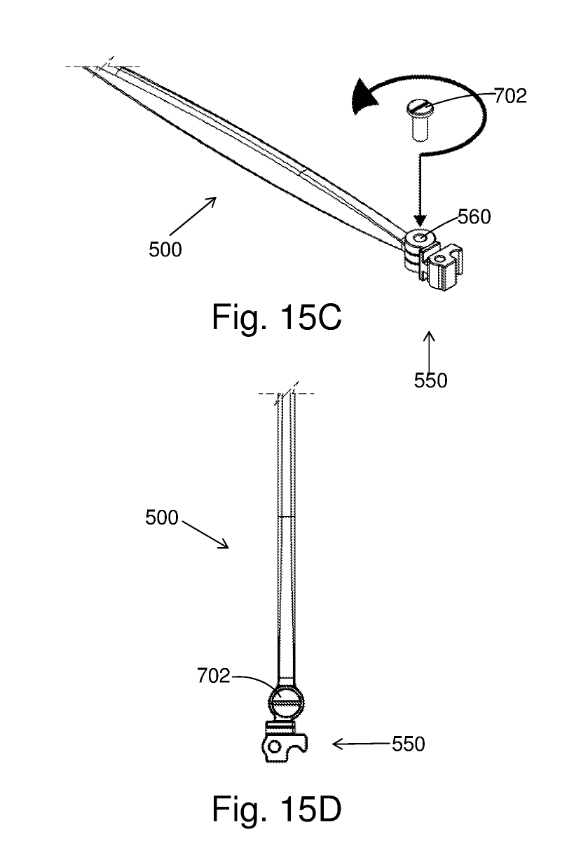

Embodiments of the left earpiece connector 250 and the left lens holder attaching element 550 and their assembly, that are illustrated in FIG. 14A-C are similar to those illustrated in FIGS. 12A-D. The difference is in the structure and function of the lens holder attaching element body 559. According to an embodiment illustrated in FIGS. 12-13, the lens holder attaching element body 559 is bent. According to another embodiment illustrated in FIGS. 12-13, the lens holder attaching element body 559 serves as a male connector, namely it comprises one lens holder attaching element body 559 and one hole 560. On the other hand, according to an embodiment illustrated in FIGS. 14-15, the lens holder attaching element body 559 is substantially straight. According to another embodiment illustrated in FIGS. 14-15, the lens holder attaching element body 559 serves as a female connector. A detailed description of the lens holder attaching element body 559 serving as a female connector is given hereinafter.

FIGS. 15A-D schematically illustrate, according to an exemplary embodiment, stages of a method for assembling a left earpiece 500 with a left lens holder attaching element 550 comprising a left lens holder attaching element body 559 serving as a female connector.

FIGS. 15A-B schematically illustrate, according to an exemplary embodiment, a side perspective view and a top view, respectively, of a left earpiece 500 and a left lens holder attaching element 550 separated one from the other. According to one embodiment, the left lens holder attaching element 550 is similar to the one illustrated for example in FIGS. 14A-B. The left lens holder attaching element 550 further comprises two holes 560 one above the other, adjacent to the protrusion-like element 554. Thus, the two holes 560 function as a female connector. An edge of the left earpiece 500 comprises a male connector configured to be engaged with the female connector of the left lens holder attaching element 550. An exemplary embodiment of the male connector of the left earpiece 500 is an earpiece protrusion 502, comprising a hole 504. During assembly, the earpiece protrusion 502 is configured to be accommodated in the female member of the left lens holder attaching element 550, that comprises two holes 560 one above the other, in a manner that the two holes 560 of the left lens holder attaching element 550 align with the hole 504 of the earpiece protrusion 502.

FIGS. 15C-D schematically illustrate, according to an exemplary embodiment, a side perspective view and a top view, respectively, of a left earpiece 500 assembled with a left lens holder attaching element 550. After the two holes 560 of the left lens holder attaching element 560 are aligned with the hole 504 of the earpiece protrusion 502, an axial element 702 is inserted into the three aligned holes 560 and 504. According to one embodiment, the axial element 702 is configured to hold the left earpiece 500 and a left lens holder attaching element 550 together. According to another embodiment, the axial element 702 is configured to serve as an axis for rotation of the left earpiece 500 in relation to the left lens holder attaching element 550. An exemplary axial element 702 is a screw.

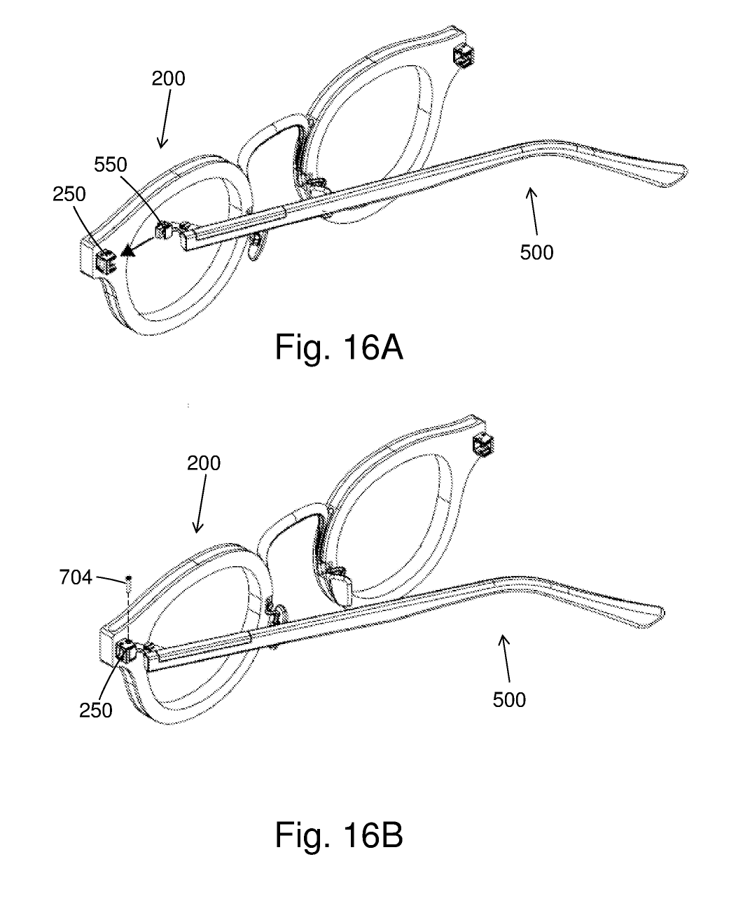

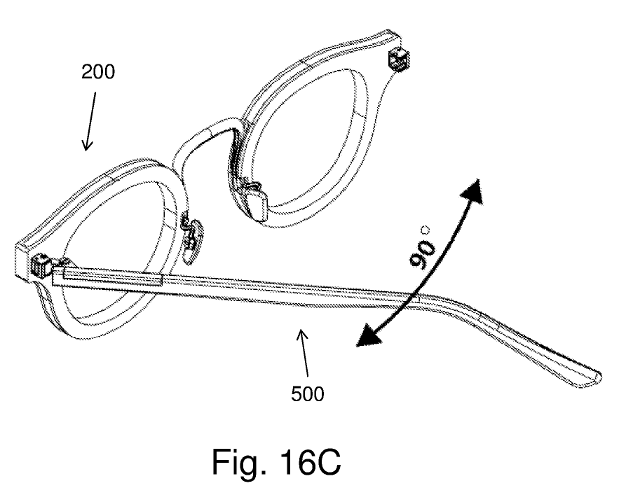

FIGS. 16A-C schematically illustrate, according to an exemplary embodiment, a side perspective view of stages of a method for assembling a left earpiece 500 with a left lens holder 200.

FIG. 16A illustrates the left earpiece 500 and the left lens holder 200 separated one from the other. The left lens holder 200 comprises a left earpiece connector 250 attached to it for example as described in FIGS. 9A-B and 11A-B. The left earpiece 500 comprises a left lens holder attaching element 550 attached to it for example as described in FIGS. 13A-D.

FIGS. 16B-C illustrate assembly of the left earpiece connector 250 with the left lens holder attaching element 550, for example as described in FIG. 12A-D.

It is appreciated that embodiments described in relation to components of one side of the eyewear system 1—left or right, refer also to components of the other side of the eyewear system—right or left.

Following is a summary of some of the additional embodiments of the modular eyewear system 1 illustrated in FIGS. 8-14.

According to one embodiment, a left earpiece connector 250 is attached to a left lens holder body 220, and/or a right earpiece connector 350 is attached to a right lens holder body 320, by any method know in the art, for example but not limited to, welding, heating and the like, depending on the type of material of which the left lens holder 200 and the right lens holder 300 are made.

According to another embodiment, the left earpiece connector 250 comprises two holes 256 configured to fix a cylinder 259 into which a locking member 258 is inserted. The right earpiece connector 350 comprises corresponding holes.

According to yet another embodiment, the left earpiece connector 250 further comprises two holes 257 configured to accommodate a fastening member 704 for fastening the left earpiece connector 250 to the left lens holder attaching element 550. The right earpiece connector 350 comprises corresponding holes.

According to still another embodiment, the left lens holder attaching element 550 is configured to attach a left earpiece 500 to the left earpiece connector 250, while the left earpiece connector 250 is attached to a left lens holder 200. The right lens holder attaching element 450 is configured to do the same with the corresponding components.

According to a further embodiment, the left lens holder attaching element 550 comprises a hole 560, or two holes 560, configured to accommodate an axial element 702 that is configured to hold the left earpiece 500 and a left lens holder attaching element 550 together through two earpiece protrusions 502 or one earpiece protrusion 502, comprising a hole 504, that the earpiece 500 comprises. The right lens holder attaching element 450 and the right earpiece 400 comprise corresponding components.

According to yet a further embodiment, the left lens holder attaching element 550 further comprises a hole 557, and the left earpiece connector 250 further comprises a hole 257, both configured, when aligned, to allow a fastening member 704 to be inserted in them in order to further fasten the left lens holder attaching element 550 with the a left earpiece connector 250. The right lens holder attaching element 550 and the right earpiece connector 350 comprise corresponding components.

According to still a further embodiment, two earpiece protrusions 502, or one earpiece protrusion 502, are attached to the left earpiece 500, each earpiece protrusion 502 comprises a hole 504. When a hole 560 at the distal edge of the left lens holder attaching element body 559 aligns with holes 504, they are configured to accommodate an axial element 702, when the axial element 702 is configured to hold the left earpiece 500 and a left lens holder attaching element 550 together, and/or serve as an axis for rotation of the left earpiece 500 in relation to the left lens holder attaching element 550. The right earpiece 400 and the right lens holder attaching element 450 comprise corresponding components.

According to an additional embodiment, an axial element 702 is configured to axially connect the left earpiece 500 with the left lens holder attaching element 550 through a hole 560, or two hole 560, at the left lens holder attaching element 550 and holes 504, or hole 504, at earpiece protrusion 502 of the left earpiece. A corresponding axial element is configured to axially connect the right earpiece 400 with the right lens holder attaching element 450.

According to yet an additional embodiment, a fastening member 704 is configured to be inserted into aligned holes 557 and 257, and further fasten the left lens holder attaching element 550 with the left earpiece connector 250.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A modular eyewear system, comprising:
a plurality of bridges; and at least one of:
a plurality of left lens holders; and
a plurality of right lens holders,
wherein any one of the bridges can be assembled with any one of the left lens holders and/or the right lens holders.

2. The modular eyewear system of claim 1, wherein
each left lens holder comprises a left lens holder body and a bridge connector;
each right lens holder comprises a right lens holder body and a bridge connector; and
each bridge comprises:
a bridge body, and at least one of:
a left lens holder connector, adapted to connect to the bridge connector of the left lens holder; and
a right lens holder connector, adapted to connect to the bridge connector of the right lens holder.

3. The modular eyewear system of claim 2, wherein the size and shape of the left lens holder connector of a bridge corresponds to the size and shape of a bridge connector of a left lens holder, in a manner that the left lens holder connector overlaps with the bridge connector, and the size and shape of the right lens holder connector of a bridge corresponds to the size and shape of a bridge connector of a right lens holder, in a manner that the right lens holder connector overlaps with the bridge connector.

4. The modular eyewear system of claim 3, wherein the size and shape of the left lens holder connectors in a plurality of bridges and the size and shape of the bridge connectors in a plurality of left lens holders is uniform, thus allowing the connection of any bridge with any left lens holder, and wherein the size and shape of the right lens holder connectors in a plurality of bridges and the size and shape of the bridge connectors in a plurality of right lens holders is uniform, thus allowing the connection of any bridge with any right lens holder.

5. The modular eyewear system of claim 4, wherein a bridge connector is a female connector having a cavity, and the corresponding left lens holder connector or the corresponding right lens holder connector is a male connector, adapted to fit into the corresponding cavity.

6. The modular eyewear system of claim 4, wherein a bridge connector is a male connector, and the corresponding left lens holder connector or the corresponding right lens holder connector is a female connector having a cavity, wherein the bridge connector is adapted to fit into the corresponding cavity.

7. The modular eyewear system of claim 1, further comprising a plurality of earpieces capable of being further assembled to a corresponding lens holder so as to complete the eyewear system.

8. A eyewear comprising:
a bridge selected from a plurality of bridges of a modular eyewear system according to claim 1, connected to at least one of:
a left lens holder selected from a plurality of left lens holders of the modular eyewear system; and
a right lens holder selected from a plurality of right lens holders of the modular eyewear.

9. The eyewear of claim 8, further comprising a left earpiece selected from a plurality of left earpieces and a right earpiece selected from a plurality of right earpieces, wherein the left earpiece is connected to the left lens holder and the right earpiece is connected to the right lens holder.

10. A method for assembling a modular eyewear comprising:
selecting a bridge from a plurality of bridges,
connecting at least one lens holder selected from a plurality of lens holders to the bridge.

11. The method of claim 10, wherein the plurality of lens holders comprises a plurality of left lens holders and a plurality of right lens holders.

12. The method of claim 10, further comprising connecting at least one earpiece selected from a plurality of earpieces.

13. The method of claim 12, wherein the plurality of earpieces comprises a plurality of right earpiece and a plurality of left earpiece.

14. The method of claim 12, wherein the connecting at least one earpiece selected from a plurality of earpieces comprising connecting the left earpiece to the left lens holder and connecting the right earpiece to the right lens holder.
